(19) United States
(12) Patent Application Publication
(10) Pub. No.: US 2025/0325967 A1
(43) Pub. Date: Oct. 23, 2025

(54) OXYGEN STORAGE MATERIAL, CATALYST FOR PURIFYING EXHAUST GAS, AND METHODS FOR MANUFACTURING OXYGEN STORAGE MATERIAL

(71) Applicant: TOHOKU UNIVERSITY, Sendai-shi, Miyagi (JP)

(72) Inventors: Hitoshi TAKAMURA, Sendai-shi (JP); Kazuto MURAKAMI, Sendai-shi (JP)

(21) Appl. No.: 18/693,025

(22) PCT Filed: Sep. 21, 2022
(86) PCT No.: PCT/JP2022/035181

§ 371 Date: Oct. 18, 2024

(30) Foreign Application Priority Data
Sep. 21, 2021 (WO) PCT/JP2021/034566

(51) Int. Cl. B01J 23/83; B01D 53/86; B01J 35/61; B01J 35/70; B01J 37/08; B01J 37/16

(52) U.S. Cl. CPC B01J 23/83; B01J 35/612; B01J 35/735; B01J 37/08; B01J 37/16; B01D 53/8678; B01J 2235/15

(57) ABSTRACT

This oxygen storage material has a chemical composition represented by Ce₁₋ₓZrₓO_{2-δ} (0.45≤x≤0.65, 0≤δ), has a peak attributed to a cubic pyrochlore-like structure (κ phase) near 14.5° in an XRD pattern, and has a specific surface area of 3 [m²/g] or more.

The present application is based on PCT/JP2021/034566 filed on Sep. 21, 2021, and the contents thereof are incorporated herein.

### TECHNICAL FIELD

The present invention relates to an oxygen storage material, a catalyst for purifying exhaust gas, and a method for producing an oxygen storage material.

### BACKGROUND ART

A three-way catalyst is used for purifying exhaust gas from an automatic vehicle or the like. The three-way catalyst is a catalyst for simultaneously removing three types of gas including carbon monoxide (CO), hydrocarbons (HC), and nitrogen oxides (NOx) in the exhaust gas. It is known that a purification rate depends on an air-fuel ratio, and CO, HC, and NOx can be simultaneously removed with high efficiency when an atmosphere of the exhaust gas is near a theoretical air-fuel ratio of 14.6. An OSC material that stores and releases oxygen is used for controlling the atmosphere near the theoretical air-fuel ratio. An oxygen storage capacity (OSC) indicates an amount of oxygen that can be stored and released by a material, which can store oxygen when an oxygen concentration in the exhaust gas is high and release oxygen when the oxygen concentration in the exhaust gas is low according to the atmosphere, and is defined by an oxygen storage and release amount [μmol-O₂·g⁻¹] per 1 g of the catalyst. Therefore, a material having a high OSC is required for the three-way catalyst.

CeO₂ attracts attention due to having a relatively high OSC. CeO₂ stores and releases oxygen according to the following reaction formula with a change in valence of Ce ions.

$$\begin{matrix}Oxygen release : {CeO}_{2} \to C e {O}_{2 - δ} + δ / 2 {O}_{2} \\ Oxygen storage : {CeO}_{2} - δ + δ / {20}_{2} \to C e {O}_{2}\end{matrix}$$

Ce ions of CeO₂ are Ce⁴⁺, and when all Ce⁴⁺ are reduced to Ce³⁺, δ becomes the largest. At this time, δ=0.5.

However, since an ion radius is increased by about 1.2 times during the reduction from Ce⁴⁺ to Ce³⁺, a strain of a crystal lattice occurs, and the lattice becomes unstable. Therefore, the strain is relaxed by introducing Zr⁴⁺ having an ion radius smaller than that of the Ce ions. This relaxation effect eliminates the instability of the crystal lattice due to the change in valence of the Ce ions, resulting in an increase in OSC. The OSC of Ce₁₋ₓZrₓO₂ varies depending on a solid solution amount of Zr and becomes maximum in a composition near x=0.5.

A CeO₂—ZrO₂-based oxide has a high OSC due to the change in valence of the Ce ions, and is widely used as a co-catalyst of an exhaust gas purification catalyst.

In relation to this Ce_{0.5}Zr_{0.5}O₂, there are a tetragonal fluorite type structure (t′ phase) in which Ce and Zr ions are randomly arranged and a cubic pyrochlore-like structure (κ phase) in which Ce and Zr ions are arranged in order in a [110] direction.

It is known that this κ phase exhibits the highest OSC in a pseudo-binary system of CeO₂—ZrO₂. The t′ phase has a reduction rate of about 50%, whereas the κ phase releases oxygen of about 90% of a theoretical value. As shown in FIG. 1, a synthesis process of the κ phase includes two steps (a first step (reduction step) and a second step (oxidation step) thereafter). In the first step (reduction step), a precursor of CeO₂—ZrO₂ is subjected to a heat treatment at a high temperature of, for example, 1200° C. or higher in a reduction atmosphere to synthesize pyrochlore phase Ce₂Zr₂O₇ in which Ce and Zr are arranged in order. Next, in the second step (oxidation step), a heat treatment is performed at, for example, about 600° C., and oxygen is introduced, thereby synthesizing κ-Ce₂Zr₂O₈. Here, the pyrochlore phase Ce₂Zr₂O₇ and the κ phase Ce₂Zr₂O₈ have the same metal ion arrangement and both have a structure in which metal ions are arranged in order (hereinafter, sometimes referred to as a “cation-ordered structure”), and a difference is only the amount of oxygen. The pyrochlore type Ce₂Zr₂O₇ having a metal-to-oxygen ratio of 4:7 is further oxidized, and the κ phase Ce₂Zr₂O₈ has a metal-to-oxygen ratio of 4:(7+1)=4:8=1:2.

NPL 3 discloses that the first step (reduction step) is performed at 1500° C. for 4 hours in an atmosphere of 10% H₂—Ar, and the second step (oxidation step) is performed at 600° C. for 4 hours in the air. In addition, NPL 3 discloses that it has been examined that a reduction temperature and a reduction time in the first step (reduction step) has a relationship with a formation ratio of the κ phase in a sample, when the reduction step is performed at 1300° C. for 4 hours, 1400° C. for 4 hours, and 1500° C. for 4 hours, the formation ratio of the κ phase is 91.2%, 97.1%, and 100%, respectively, and when the reduction step is performed at 1500° C. for 30 minutes, 1 hour, and 2 hours, the formation ratio of the κ phase is 72.5%, 85.0%, and 95.0%, respectively. Here, the formation ratio of the κ phase in the sample is obtained based on an intensity ratio [I(14/29) value] of an intensity of a diffraction line at 2θ=14.5° and an intensity of a diffraction line at 2θ=29° in an X-ray diffraction pattern.

NPL 4 discloses that the first step (reduction step) is performed at 1200° C. and the second step (oxidation step) is performed at 500° C.

On the other hand, PTL 2 discloses that “a composite oxide comprising CeO₂ and ZrO₂, having one or more phases of a pyrochlore phase, a κ phase, and an intermediate phase of both phases, and having a specific surface area of 20 m²/g or more” (Claim 1). PTL 2 discloses that, in any of synthesis processes of Examples and Comparative Examples, the first step (reduction step) is performed, but does not disclose that the second step (oxidation step) is performed. Specifically, it is disclosed in Example 1 that “the obtained powder was subjected to a reduction treatment at 1000° C. for 2 hours in an N₂ air flow containing 4% of H₂ to obtain a composite oxide powder of the invention” (paragraph 0041), and it is disclosed in Example 2 that “the powder was subjected to the reduction treatment at 900° C. for 2 hours in the N₂ air flow containing 4% of H₂ to obtain a composite oxide powder of the invention” (paragraph 0043). Since the second step (oxidation step) is not performed, it is considered that the κ phase is not obtained. Further, in both Example 1 and Example 2, since the temperature in the first step (reduction step) is lower than 1200° C. as described above, it is unknown whether the cation-ordered structure is obtained on the premise of the κ phase. As described later, a peak near 2θ=15° in an XRD pattern is known as a piece of evidence supporting the presence of the cation-ordered structure, but an XRD pattern shown in FIG. 2 of PTL 2 shows only a low angle up to 25°, which does not support the presence of the cation-ordered structure.

As an approach for improving catalyst activity of a ceria-zirconia (CeO₂—ZrO₂) composite oxide, it is known that iron (Fe) is formed as a solid solution in the CeO₂—ZrO₂ composite oxide (for example, PTL 3).

Since the ion radius of Fe³⁺ is smaller than the ion radius of Zr⁴⁺, it is considered that Fe ions are selectively substituted with Zr sites, oxygen defects are generated in the ceria-zirconia-based composite oxide in which iron is formed as a solid solution due to such substitution with Fe ions, and the oxygen defects improve activity of oxygen in the composite oxide to exhibit an excellent oxygen storage capacity (OSC) (see paragraph 0021 of PTL 3).

PTL 3 discloses an oxygen storage material (Claim 1) “comprising a pyrochlore type ceria-zirconia-based composite oxide and iron added to the ceria-zirconia-based composite oxide, wherein a content ratio of iron to a total amount of cerium (Ce) and zirconium (Zr), i.e., (Fe/(Ce+Zr)×100), is 0.5 at % to 9 at %, and a molar fraction of zirconium to a total number of moles of cerium (Ce) and zirconium (Zr), i.e., (X=Zr/(Ce+Zr)×100), is X=40% to 50%”. In addition, it describes a reason why it can be determined that iron is sufficiently formed as a solid solution in the iron-containing pyrochlore type ceria-zirconia-based composite oxide in the oxygen storage material based on a lattice constant and the intensity ratio of the diffraction line of 2θ=14.5° to the diffraction line of 2θ=29°, which are obtained from an X-ray diffraction pattern obtained by an X-ray diffraction measurement using CuKα before heating at 1100° C. and after heating for 5 hours in the air (see paragraphs 0017 to 0021). In order to sufficiently cause iron to be formed as a solid solution in this manner, it is disclosed that an iron-containing ceria-zirconium solid solution obtained by a coprecipitation method is pulverized to obtain an iron-containing ceria-zirconium solid solution powder, and the powder is pressure-molded under a pressure of 30 MPa to 350 MPa, then subjected to a reduction treatment under a temperature condition of 1400° C. to 2000° C., and further subjected to an oxidation treatment to produce an oxygen storage material (see Claim 3). In Example 1, the reduction treatment is performed at 1700° C. for 4 hours.

### CITATION LIST

### Patent Literature

PTL 1: WO 2017/213038
PTL 2: JP2005-170554A
PTL 3: JP2022-59284A

### Non Patent Literature

NPL 1: Y. Goto et al., Chem. Commun, 54 (2018) 3528-3531.
NPL 2: Noriya Izu et al., J. Alloys Compd., 270 (1998) 107-114.
NPL 3: Y. Ding et al., Catalyst Today, 327 (2019), 262-270.
NPL 4: Y. Nagai et al., Catalyst Today, 74 (2002), 225-234.

### SUMMARY OF INVENTION

### Technical Problem

It has been reported that the high-temperature heat treatment (first step (reduction step)) at 1200° C. or higher in the κ phase synthesis process in the related art causes a great decrease in specific surface area, and specifically, it has been reported that the specific surface area of the t′ phase is 17.08 [m²/g] while the specific surface area of the κ phase is 0.35 [m²/g], which is about 1/50 of the specific surface area of the t′ phase (see NPL 1). NPL 3 discloses that when a precursor of CeO₂—ZrO₂ is synthesized by the coprecipitation method, the specific surface area of the precursor is 64 [m²/g], but the specific surface area after a reduction treatment is 1 [m²/g] or less. In addition, it is also disclosed that when the precursor of CeO₂—ZrO₂ is synthesized by a solvent-thermal method, the specific surface area of the precursor is 35 [m²/g], but the specific surface area after a reduction treatment is 2 [m²/g] to 3 [m²/g].

As described above, although the κ phase has a reduction rate (“89%” (see NPL 4)) higher than that of the t′ phase, oxygen is stored and released via a surface, and thus, there is a problem that it is difficult to put the κ phase into practical use since the specific surface area is greatly decreased.

Here, the composite oxide of PTL 2 is described to have a specific surface area with a very high value of 20 [m²/g] or more (Claim 1), and the specific surface areas of Example 1 and Example 2 after the reduction treatment (corresponding to the first step) are 25 [m²/g] and 52 [m²/g], respectively, while the specific surface area of Comparative Example 2 (paragraph 0048) in which the reduction treatment is not performed is 105 [m²/g](see Table 1). It is considered that the high specific surface areas of Example 1 and Example 2 are results of the formation of the pyrochlore phase not proceeding in the composite oxide and the remaining of a large amount of the t′ phase. In Example 1 and Example 2, the formation of the pyrochlore phase, which is the premise of the κ phase, does not proceed, and the oxidation treatment (corresponding to the second step) for forming the κ phase by introducing oxygen into vacant sites of the pyrochlore phase is not performed. Therefore, it is considered that Examples having high specific surface areas of 20 [m²/g] or more described in PTL 2 do not contain the κ phase, or even if the κ phase is contained, the amount thereof is very small.

As a result of intensive studies, the present inventors have found a method of obtaining the κ phase by a reduction heat treatment at a temperature lower than 1200° C., and made it possible to prepare a CeO₂—ZrO₂ oxide containing a κ phase having a specific surface area larger than that in the related art, thereby completing the invention.

In this method, the reduction heat treatment is performed by adding a Fe oxide during a reduction treatment of the CeO₂—ZrO₂ oxide, whereby a cation-ordered structure can be obtained by the reduction treatment at a low temperature as compared with the related art, thereby preventing growth of crystal grains, and as a result, a decrease in specific surface area is prevented.

The invention has been made in view of the above circumstances, and provides an oxygen storage material including a CeO₂—ZrO₂ oxide containing a κ phase having a specific surface area larger than that in the related art, a catalyst for purifying exhaust gas, and a method for producing an oxygen storage material.

### Solution to Problem

In order to solve the above problems, the invention provides the following means.

An oxygen storage material according to a first aspect of the invention has a chemical composition represented by Ce₁₋ₓZrₓO_{2-δ} (0.45≤x≤0.65, 0≤δ), has a peak attributed to a cubic pyrochlore-like structure (κ phase) near 14.5° in an XRD pattern, and has a specific surface area of 3 [m²/g] or more.

The oxygen storage material according to the above aspect may have a specific surface area of 3.5 [m²/g] or more.

The oxygen storage material according to the above aspect may have a specific surface area of 5 [m²/g] or more.

The oxygen storage material according to the above aspect may have a peak attributed to Fe in the XRD pattern.

A catalyst for purifying exhaust gas according to a second aspect of the invention contains the oxygen storage material according to the above aspect.

A method for producing an oxygen storage material according to a third aspect of the invention includes a composite preparation stage of preparing a composite in which a Fe compound is added to an oxide having a chemical composition represented by Ce₁₋ₓZrₓO_{2-δ} (0.45≤x≤0.65, 0≤δ), and a reduction heat treatment stage of subjecting the composite to a reduction heat treatment at a temperature of 700° C. or higher and 850° C. or lower.

In the method for producing an oxygen storage material according to the above aspect, in the composite preparation stage, the Fe compound may be added in an amount of 1 vol % or more and 10 vol % or less with respect to the oxide having the chemical composition represented by Ce₁₋ₓZrₓO_{2-δ} (0.45≤x≤0.65, 0≤δ).

### Advantageous Effects of Invention

According to the invention, it is possible to provide an oxygen storage material including a CeO₂—ZrO₂ oxide containing a κ phase having a larger specific surface area than that in the related art.

### BRIEF DESCRIPTION OF DRAWINGS

FIG. 1 is a diagram schematically showing a κ phase synthesis process.

FIG. 2 is a diagram conceptually showing a state in which exhaust gas is purified using a catalyst for purifying according to the present embodiment fixed to a carrier.

FIG. 3 shows XRD patterns of a calcined powder of Ce_{0.5}Zr_{0.5}O₂ prepared by a Pechini method and Ce_{0.5}Zr_{0.5}O₂ after addition of Fe₃O₄, γ-Fe₂O₃, and α-Fe₂O₃.

(a) in FIG. 4 shows XRD patterns after reduction of additive-free Ce_{0.5}Zr_{0.5}O₂ and samples added with Fe₃O₄, γ-Fe₂O₃, and α-Fe₂O₃, and (b) in FIG. 4 is an enlarged diagram near 2θ=14.5°.

FIG. 5 shows Raman spectra obtained by reducing additive-free Ce_{0.5}Zr_{0.5}O₂ and a sample added with α-Fe₂O₃ or oxidizing additive-free Ce_{0.5}Zr_{0.5}O₂ and the sample after reduction.

(a) in FIG. 6 is a graph showing reduction time dependence of an XRD pattern of Ce_{0.5}Zr_{0.5}O₂-5 vol % γ-Fe₂O₃, and (b) in FIG. 6 is an enlarged diagram near 2θ=14.5°.

(a) in FIG. 7 is a graph showing reduction time dependence of an XRD pattern of Ce_{0.5}Zr_{0.5}O₂-5 vol % Fe₃O₄, and (b) in FIG. 7 is an enlarged diagram near 2θ=14.5°.

FIG. 8 is an XRD pattern of a sample added with γ-Fe₂O₃ and Ce_{0.5}Zr_{0.5}O₂ prepared by a solid-state reaction method.

FIG. 9 shows an XRD pattern obtained after a reduction heat treatment in an atmosphere of 5% H₂—Ar at 800° C. for 3 hours.

FIG. 10 is a graph comparing specific surface areas of a t′ phase prepared by the Pechini method and a κ phase prepared by adding 5 vol % α-Fe₂O₃ to the t′ phase.

FIG. 11 is a conceptual diagram showing a mechanism related to cation ordering of a ceria-zirconia composite oxide related to the presence of Fe ions.

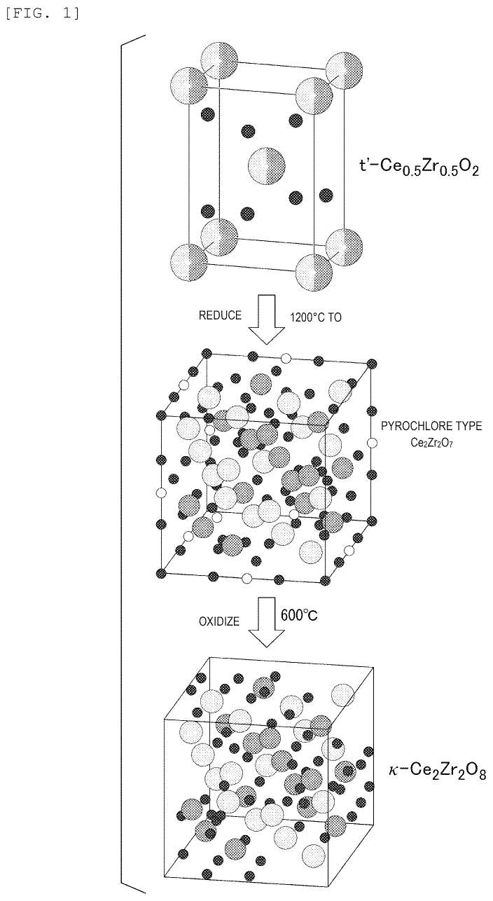

(a) in FIG. 12 is a photograph on which a model interface is formed by depositing a Fe₂O₃ thin film on a t′ phase CZ55 powder layer having a thickness of 3 μm by PLD, and a mapping image obtained by performing line scanning on a boundary between a region (region 1) where the Fe₂O₃ thin film is deposited and a region (region 2) where the Fe₂O₃ thin film is not deposited by a Raman spectrum method after a reduction heat treatment, and (b) in FIG. 12 shows a Raman spectrum of each original mapping image shown in (a) in FIG. 12.

### DESCRIPTION OF EMBODIMENTS

Hereinafter, an oxygen storage material, a catalyst for purifying exhaust gas, and a method for producing an oxygen storage material according to an embodiment to which the invention is applied will be described in detail.

### (Oxygen Storage Material)

An oxygen storage material can release oxygen when oxygen is insufficient and can store oxygen when oxygen is excessive in a three-way catalyst. Accordingly, even when an air-fuel ratio deviates from an ideal range, three types of gas including carbon monoxide, hydrocarbons, and nitrogen oxides in an exhaust gas can be simultaneously removed.

An oxygen storage material according to the present embodiment has a chemical composition represented by Ce₁₋ₓZrₓO_{2-δ} (0.45≤x≤0.65, 0≤δ), has a peak attributed to a cubic pyrochlore-like structure (κ phase) near 14.5° in an XRD pattern, and has a specific surface area of 3 [m²/g] or more.

### <Chemical Composition>

The oxygen storage material according to the present embodiment has the chemical composition represented by Ce₁₋ₓZrₓO_{2-δ} (0.45≤x≤0.65, 0≤δ). The oxygen storage material according to the present embodiment preferably has a chemical composition represented by Ce₁₋ₓZrₓO_{2-δ} (0.45≤x≤0.60, 0≤δ), and more preferably has a chemical composition represented by Ce₁₋ₓZrₓO_{2-δ} (0.45≤x≤0.55, 0≤δ).

As shown in Examples, the chemical composition is represented by Ce_{0.5}Zr_{0.5}O₂, but it is known that a κ phase is obtained when x is in the range of 0.45≤x≤0.65 (see NPL 2).

In a simple substance of CeO₂, oxygen on a crystal surface mainly contributes to OSC characteristics, and in CeO₂—ZrO₂, oxygen inside a crystal also contributes to an OSC. Therefore, a CeO₂—ZrO₂-based oxide has a high OSC. In Ce₁₋ₓZrₓO₂, a highest OSC characteristic is obtained near x=0.5. When oxygen in Ce_{0.5}Zr_{0.5}O₂ is released, Ce_{0.5}Zr_{0.5}O_{2-δ} is obtained. When a valence of Zr ions does not change, the largest 5 is 0.25. Ce₁₋ₓZrₓO₂ has a plurality of phases such as a t′ phase and a κ phase. As the oxygen storage material, the t′ phase or the κ phase is mainly used. The t′ phase is a tetragonal phase. The κ phase is a phase having a pyrochlore-like structure.

In addition, it is sufficient that 0≤δ. Theoretically, in the case of Ce_{0.5}Zr_{0.5}O_{2-δ}, 0≤δ≤0.25, and when x is close to 0, 0≤δ≤0.5.

### <XRD Pattern>

The oxygen storage material according to the present embodiment has a peak attributed to a cubic pyrochlore-like structure (κ phase) near 14.5° in the XRD pattern.

In the present description, “having a peak attributed to a cubic pyrochlore-like structure (κ phase)” means that a peak appears near 14.5° in the XRD pattern to the extent that the peak can be specified to attribute to the cubic pyrochlore-like structure (κ phase). When an intensity of the peak attributed to the κ phase is weak, the peak can be checked by expanding a range of 2θ including 14.5°. As will be described later, since formation of the κ phase can also be checked by Raman spectroscopy, the presence of the peak attributed to the κ phase can be determined by using Raman spectroscopy in combination.

In addition, in the present description, “near 14.5°” means that it is sufficient to specify the peak attributed to the pyrochlore-like structure (κ phase), and it is intended not to be strictly limited to 14.5° in consideration of a deviation depending on measurement conditions, an apparatus, and the like in an actual measurement.

The oxygen storage material according to the present embodiment may have a peak attributed to Fe in the XRD pattern.

Since the oxygen storage material according to the present embodiment is subjected to a reduction heat treatment by adding a Fe compound, Fe remains in the oxygen storage material at a stage of preparation. Since Fe itself is considered to have no influence or have a small influence on the OSC, the oxygen storage material can be used while Fe remains. When Fe remains, a Fe compound may be formed in the oxygen storage material. In addition, when Fe flows due to an acid or the like, the oxygen storage material does not contain or hardly contains Fe.

### <Specific Surface Area>

The oxygen storage material according to the present embodiment has a specific surface area of 3 [m²/g] or more. The specific surface area is preferably 3.5 [m²/g] or more, more preferably 4 [m²/g] or more, and still more preferably 5 [m²/g] or more.

In the present description, a value of “specific surface area” is a value obtained by adsorbing nitrogen molecules at a liquid nitrogen temperature of 77K and calculating the specific surface area based on an adsorption isotherm using a BET theory. The “specific surface area” can be measured by using, for example, a gas adsorption amount measuring apparatus BELSORP 18 Plus (manufactured by BEL JAPAN, Inc. (current MicrotracBEL Corp.)).

When a crystal grain becomes larger, a surface with respect to the entire crystal grain becomes smaller, and thus the specific surface area becomes smaller. The crystal grain grows as a temperature increases during the heat treatment. In the related art, it is necessary to perform a reduction heat treatment at 1200° C. or higher during the preparation of the κ phase, whereas the κ phase can be obtained even at 800° C. according to the invention. In the κ phase of the invention, since the κ phase can be prepared at a temperature lower than that in the related art, growth of the crystal grain is prevented as compared with the related art, and the specific surface area is increased.

The oxygen storage material according to the present embodiment can be used together with a three-way catalyst as a main catalyst.

The oxygen storage material according to the present embodiment can be used by being fixed to a carrier. Examples of the carrier include alumina (Al₂O₃), zirconia (ZrO₂), magnesia (MgO), and silica (SiO₂).

### (Method for Producing Oxygen Storage Material)

A method for producing an oxygen storage material according to the present embodiment includes a composite preparation stage of preparing a composite in which a Fe compound is added to an oxide having a chemical composition represented by Ce₁₋ₓZrₓO_{2-δ} (0.45≤x≤0.65, 0≤δ), and a reduction heat treatment stage of subjecting the composite to a reduction heat treatment at a temperature of 700° C. or higher and 850° C. or lower.

A method for preparing an oxide having a chemical composition represented by Ce₁₋ₓZrₓO_{2-δ} (0.45≤x≤0.65, 0≤δ) is not particularly limited, and for example, a Pechini method or a general solid-state reaction method as a method for synthesizing ceramics can be used.

A method for preparing a composite in which a Fe compound is added to the oxide having a chemical composition represented by Ce₁₋ₓZrₓO_{2-δ} (0.45≤x≤0.65, 0≤δ) is also not particularly limited, and for example, it can be prepared by mixing in a planetary ball mill.

The temperature in the reduction heat treatment in the reduction heat treatment stage is preferably 750° C. or higher and 850° C. or lower. The temperature in the reduction heat treatment is preferably 800° C.±30° C.

### <Fe Compound>

Examples of the Fe compound to be added include Fe oxides such as Fe₂O₃ and Fe₃O₄, and Fe-containing oxides containing metals other than Fe such as CoFe₂O₄.

An addition amount of the Fe compound in the composite preparation stage is preferably 1 vol % or more and 10 vol % or less with respect to the oxide having the chemical composition represented by Ce₁₋ₓZrₓO_{2-δ} (0.45≤x≤0.65, 0≤δ).

The addition amount of the Fe compound is preferably 2 vol % or more, and more preferably 3 vol % or more, with respect to the oxide having the chemical composition represented by Ce₁₋ₓZrₓO_{2-δ} (0.45≤x≤0.65, 0≤δ).

The addition amount of the Fe compound is preferably 8 vol % or less, and more preferably 7 vol % or less, with respect to the oxide having the chemical composition represented by Ce₁₋ₓZrₓO_{2-δ} (0.45≤x≤0.65, 0≤δ).

After the reduction heat treatment stage, an oxidation treatment is performed at a temperature of 300° C. to 800° C. For example, the oxidation treatment can be performed at 600° C.

### (Catalyst for Purifying Exhaust Gas)

A catalyst for purifying exhaust gas according to the present embodiment contains the above-described oxygen storage material according to the invention.

The oxygen storage material according to the invention may be contained together with the main catalyst as a co-catalyst, or may be used alone as the catalyst for purifying exhaust gas.

When the catalyst for purifying exhaust gas according to the present embodiment contains the oxygen storage material according to the invention as the co-catalyst, a known three-way catalyst precious metal can be used as the main catalyst. Specific examples of the known three-way catalyst precious metal include rhodium, platinum, and palladium.

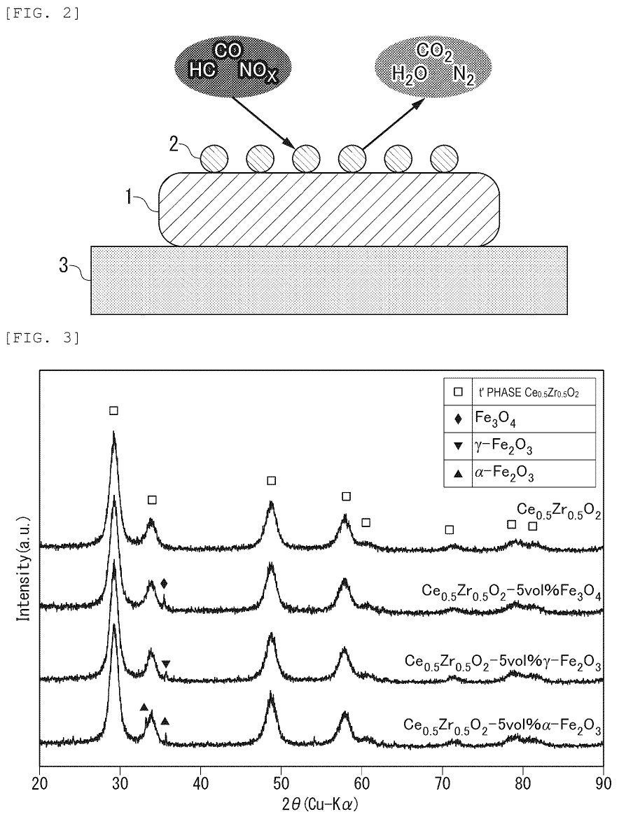

As shown in FIG. 2, the catalyst for purifying exhaust gas according to the present embodiment can be used by being fixed to the carrier. In FIG. 2, reference numeral 1 denotes the oxygen storage material, reference numeral 2 denotes the three-way catalyst as the main catalyst, and reference numeral 3 denotes the carrier. Examples of the carrier according to the invention include alumina (Al₂O₃), zirconia (ZrO₂), magnesia (MgO), and silica (SiO₂).

### EXAMPLES

### 1. Preparation of Sample Powder

### (1) Preparation by Pechini Method

Hereinafter, a step of preparing a CeO₂—ZrO₂ sample using the Pechini method will be described. The Pechini method is a kind of liquid phase synthesis method, and has an advantage that metal ions can be mixed at an atomic level and a uniform and fine product can be obtained, although a generation amount that can be prepared at one time is smaller than that in a solid-state method. Metal nitrates, citric acid, and propylene glycol shown in Table 1, and distilled water in an amount of ½ of a weight of citric acid were added to obtain the desired composition, and the mixture was stirred for 24 hours. Thereafter, the temperature was increased stepwise from room temperature to 300° C. by a hot stirrer to prepare a precursor. The completely solidified precursor was held in an electric furnace at 200° C., 300° C., and 400° C. for 2 hours each to perform carbonization. Thereafter, the mixture was pulverized in a mortar for about 10 minutes, then further calcined in the air at 800° C. for 2 hours, and pulverized in a planetary ball mill at 400 rpm for 2 hours to form fine particles. After ball milling, 2-propanol was sufficiently dried and mixed by hand for about 10 minutes in an agate mortar to obtain a powder sample. A heating rate was 5° C./min in the process of the carbonization and 10° C./min in the process of the calcination.

TABLE 1

| Element | Composition | Purity (%) | Mixing mole ratio*¹ |
|---|---|---|---|
| Ce | Ce(NO₃)₃•6H₂O | 99.9 | 1:3:3 |
| Zr | ZrO(NO₃)₂•2H₂O | 99 | 1:9:9 |

*¹Mixing mole ratio = cation:citric acid:propylene glycol

### (2) Preparation by Solid-State Reaction Method

Hereinafter, a step of preparing the CeO₂—ZrO₂ sample using the solid-state reaction method will be described.

The CeO₂—ZrO₂ sample was prepared by the general solid-state reaction method as the method for synthesizing ceramics, different from the Pechini method. In the solid-state reaction method, raw material powders such as oxides and carbonates are mixed, then atoms are diffused by a heat treatment at a high temperature, and the reaction proceeds. Although uniformity of the sample is inferior to that of the liquid phase method, a large amount of sample can be prepared at one time. Raw materials CeO₂ (manufactured by Anan Kasei Co., Ltd.) and ZrO₂ (manufactured by Kojundo Chemical Lab. Co., Ltd.) were weighed so as to satisfy Ce_{0.5}Zr_{0.5}O₂, and then mixed in a planetary ball mill at 300 rpm for 2 hours. After ball milling, 2-propanol was sufficiently dried, and the mixed powder was pelletized using a hydraulic single-shaft hand press under a condition of 35 MPa for 1 minute. Thereafter, isostatic compression molding was performed at 250 MPa for 1 minute using a cold isostatic press machine (CPA-50s, NPa System, Co., Ltd.). The temperature was increased to 1600° C. at 10° C./min and held for 10 hours in calcination. The calcined pellets were coarsely pulverized in an HD mortar and pulverized in a planetary ball mill at 300 rpm for 12 hours to obtain a calcined powder.

(3) Preparation Ce_{0.5}Zr_{0.5}O₂—Fe Oxide Composite

A composite of a Fe oxide and Ce_{0.5}Zr_{0.5}O₂ prepared by the Pechini method and the solid-state reaction method was prepared by performing mixing in a planetary ball mill at 300 rpm for 1 hour. As the Fe oxide, Fe₃O₄ (manufactured by FUJIFILM Wako Pure Chemical Corporation), α-Fe₂O₃ (manufactured by Kojundo Chemical Lab. Co., Ltd.), and γ-Fe₂O₃ (manufactured by Kojundo Chemical Lab. Co., Ltd.) were used, and an addition amount thereof was about 5 vol % with respect to the amount of Ce_{0.5}Zr_{0.5}O₂.

The crystal structures of α-Fe₂O₃ and γ-Fe₂O₃ are different, α-Fe₂O₃ is a corundum type, and γ-Fe₂O₃ is a spinel type.

### 2. Evaluation of Materials

### (1) Phase Identification Method

For phase identification of the prepared sample, powder X-ray diffraction (XRD) (D8 Advance, Bruker) was used. The powder sample was filled in a dedicated glass holder and was subjected to a measurement. All samples were measured by a concentration optical system. Cu—Kα rays were used as an X-ray source, a tube bulb voltage was 40 kV, and a filament current was 40 mA. In addition to XRD, a microscopic Raman spectroscopy apparatus (HR-800 manufactured by HORIBA, Ltd.) was used for the phase identification of the sample. A He—Ne laser (λ=632.84 nm) was used as an excitation source. The sample was expanded by an objective lens of 100 times using an optical microscope, and a grading of 600 lines/nm was used. A confocal hole value was 1000 μm, and a slit value was 100 μm. In the measurement, a subtractive filter having an optical density of 0.3 to 1 was used.

For the measurement of the specific surface area, a high-precision fully automatic gas adsorption apparatus (BELSORP 18 PLUS, BEL JAPAN, Inc.) was used. About 1 g of the sample powder was weighed and charged into a tube. The powder in the sample tube was subjected to a heat treatment in a pretreatment system of the adsorption apparatus at 350° C. for 2 hours under vacuum to remove adsorbed water and the like. The measurement was performed using nitrogen as adsorption species at a liquefied nitrogen temperature (77K). The measurement was performed in a range of an introduction pressure of 0.2 kPa to 0.95 relative pressure of an actually measured saturated vapor pressure. Based on the obtained adsorption isotherm, the specific surface area was determined based on the BET theory.

(2) Crystal Structure Evaluation on Ce_{0.5}Zr_{0.5}O₂—Fe Oxide Composite

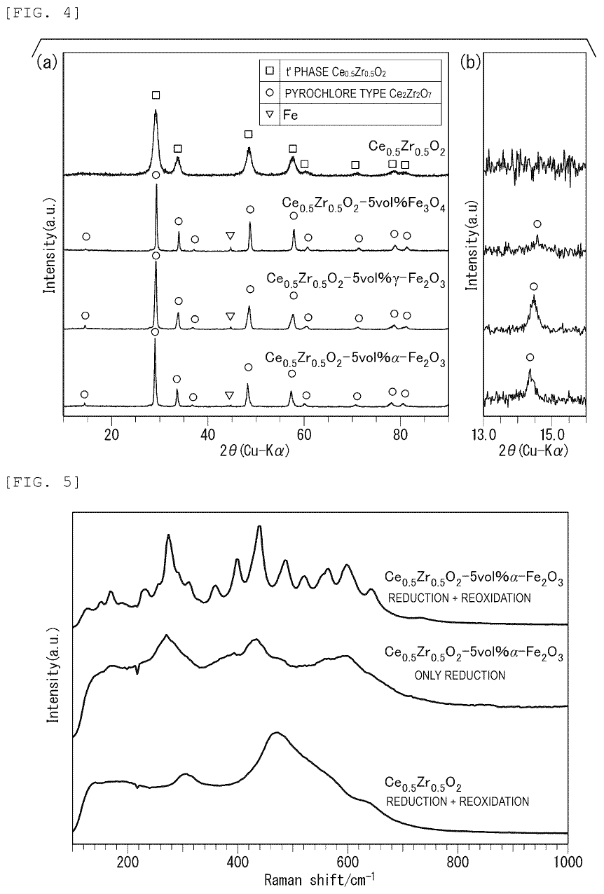

FIG. 3 shows XRD patterns of a calcined powder of Ce_{0.5}Zr_{0.5}O₂ prepared by the Pechini method and Ce_{0.5}Zr_{0.5}O₂ after addition of Fe₃O₄, γ-Fe₂O₃, and α-Fe₂O₃. The four XRD patterns in FIG. 3 are, in order from the top, an XRD pattern of the calcined powder of Ce_{0.5}Zr_{0.5}O₂, an XRD pattern of a sample after addition of Fe₃O₄, an XRD pattern of a sample after addition of γ-Fe₂O₃, and an XRD pattern of a sample after addition of α-Fe₂O₃. Regarding Ce_{0.5}Zr_{0.5}O₂, all of the observed peaks were attributed to a tetragonal fluorite type structure of Ce_{0.5}Zr_{0.5}O₂ having a space group P4₂/nmc. In each sample to which the Fe oxide was added, the same peak as that of the raw material was observed.

In the XRD pattern, a peak indicated by “□” attributes to the tetragonal fluorite type structure, a peak indicated by “♦” is a peak attributed to Fe₃O₄, a peak indicated by “▾” is a peak attributed to γ-Fe₂O₃, and a peak indicated by “▴” is a peak attributed to α-Fe₂O₃.

(3) Crystal Structure Evaluation on Sample after Reduction Heat Treatment

(a) in FIG. 4 shows XRD patterns after reduction of additive-free Ce_{0.5}Zr_{0.5}O₂ and samples added with Fe₃O₄, γ-Fe₂O₃, and α-Fe₂O₃. (b) in FIG. 4 is an enlarged diagram near 2θ=14.5°. The XRD pattern is obtained for a sample after a reduction heat treatment and before an oxidation treatment.

The pyrochlore type Ce₂Zr₂O₇ obtained by the reduction heat treatment is subjected to an oxidation treatment at an appropriate temperature to introduce oxygen to obtain K phase Ce₂Zr₂O₈. As described above, both the pyrochlore type Ce₂Zr₂O₇ and the κ phase Ce₂Zr₂O₈ have a structure in which cations are arranged in order.

Although the additive-free Ce_{0.5}Zr_{0.5}O₂ has the tetragonal fluorite type structure, when the phase is changed to pyrochlore type Ce₂Zr₂O₇ in which cations are arranged in order by the reduction heat treatment, a peak derived from the ordering of cations appears near 14.5° in the XRD pattern.

A main difference between the crystal structure of the fluorite type Ce_{0.5}Zr_{0.5}O₂ and the crystal structure of the pyrochlore type Ce₂Zr₂O₇ (crystal structure of κ phase Ce₂Zr₂O₈) is due to whether cations are arranged in order or randomly arranged. Therefore, a peak appears at a very close position in the XRD pattern. Among them, since the peak near 14.5° appears only when the cations are in order, the presence or absence of this peak serves as an index for distinguishing the pyrochlore type Ce₂Zr₂O₇ from the fluorite type Ce_{0.5}Zr_{0.5}O₂.

The reduction heat treatment was performed under a condition of an atmosphere of 5% H₂—Ar at 800° C. for 3 hours. In the case of the additive-free Ce_{0.5}Zr_{0.5}O₂, a peak of the tetragonal fluorite type structure was observed even after the reduction. On the other hand, in the samples added with Fe₂O₃ and Fe₃O₄, a peak derived from the ordering of cations was observed near 14.5°, and the phase change to the pyrochlore type Ce₂Zr₂O₇ was confirmed. In particular, in the sample added with Fe₂O₃, as compared with Fe₃O₄, a peak near 14.5° is remarkably observed, and it is considered that pyrochlore type Ce₂Zr₂O₇ having a higher degree of ordering is obtained.

In the XRD patterns in FIG. 4, a peak indicated by “□” attributes to a tetragonal fluorite type structure of fluorite type Ce_{0.5}Zr_{0.5}O₂, a peak indicated by “◯” is a peak attributed to pyrochlore type Ce₂Zr₂O₇, and a peak indicated by “ [symbol] ” is a peak attributed to Fe.

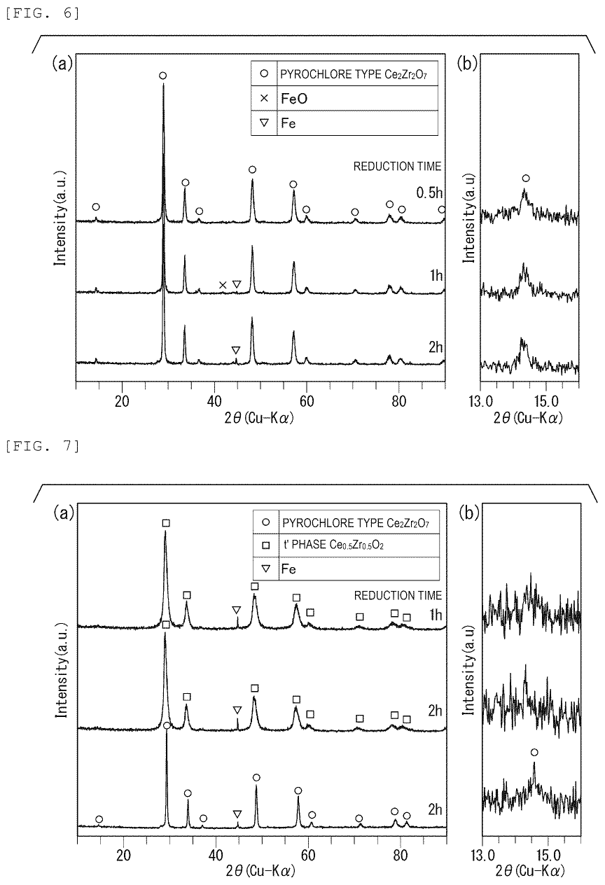

FIG. 5 shows a Raman spectrum of additive-free Ce_{0.5}Zr_{0.5}O₂, a Raman spectrum when an α-Fe₂O₃ added sample is subjected only to reduction, and a Raman spectrum in the case of reoxidation after reduction. The reduction heat treatment was performed under a condition of an atmosphere of 5% H₂—Ar at 800° C. for 3 to 5 hours, and the oxidation treatment was performed under a condition of the air at 800° C. for 2 hours. In the Raman spectrum shown in FIG. 5, in the α-Fe₂O₃ added sample in which the peak is observed near 14.5° in the powder X-ray diffraction pattern (FIG. 4), peaks attributed to the pyrochlore type structure can be observed near 280 cm⁻¹, 440 cm⁻¹, and 600 cm⁻¹ after reduction. After oxidation, a plurality of peaks attributed to the κ phase at 400 cm⁻¹ to 600 cm⁻¹ can be observed in addition to the strong peaks near 280 cm⁻¹ and 440 cm⁻¹. Therefore, formation of the κ phase can be confirmed by using the X-ray diffraction and the Raman spectroscopy in combination.

(4) Influence 1 of Reduction Time on Formation of Pyrochlore Type Ce₂Zr₂O₇

With (3), regarding the samples added with Fe₂O₃ and Fe₃O₄, an influence of a time required for the formation of pyrochlore type Ce₂Zr₂O₇ was examined. The reduction heat treatment was performed under a condition of an atmosphere of 5% H₂—Ar at 800° C., and the oxidation treatment was performed under a condition of the air at 800° C. for 2 hours. (a) in FIG. 6 shows reduction time dependence of an XRD pattern of Ce_{0.5}Zr_{0.5}O_{2-δ} vol % γ-Fe₂O₃. (b) in FIG. 6 is an enlarged diagram near 2θ=14.5°. It was found that, due to reduction for 30 minutes, in Ce_{0.5}Zr_{0.5}O_{2-δ} vol % γ-Fe₂O₃, the peak near 14.5° was observed and the phase changed to pyrochlore type Ce₂Zr₂O₇.

In the XRD pattern of (a) in FIG. 6, a peak indicated by “◯” is the peak attributed to pyrochlore type Ce₂Zr₂O₇, a peak indicated by “x” is a peak attributed to FeO, and a peak indicated by “ [symbol] ” is a peak attributed to Fe.

### (5) Influence 2 of Reduction Time on Formation of κ Phase

(a) in FIG. 7 shows reduction time dependence of an XRD pattern of Ce_{0.5}Zr_{0.5}O_{2-δ} vol % Fe₃O₄. (b) in FIG. 7 is an enlarged diagram near 2θ=14.5°. The reduction heat treatment was performed under a condition of an atmosphere of 5% H₂—Ar at 800° C. After the reduction heat treatment for 1 hour and 2 hours, the peak near 14.5° was not observed. Based on the above, it was found that in the case of Ce_{0.5}Zr_{0.5}O_{2-δ} vol % Fe₃O₄, a reduction heat treatment for about 3 hours was required for the phase change to pyrochlore type Ce₂Zr₂O₇.

In the XRD pattern of (a) in FIG. 7, a peak indicated by “□” attributes to fluorite type Ce_{0.5}Zr_{0.5}O₂, a peak indicated by “◯” is a peak attributed to pyrochlore type Ce₂Zr₂O₇, and a peak indicated by “ [symbol] ” is a peak attributed to Fe.

(6) Crystal Structure Evaluation on Sample after Reduction Heat Treatment of Ce_{0.5}Zr_{0.5}O₂—Fe Oxide Composite Using Ce_{0.5}Zr_{0.5}O₂ Prepared by Solid-State Reaction Method

The CeO₂—ZrO₂ sample was also prepared by the solid-state reaction method which is the general method for synthesizing ceramics, and a low-temperature synthesis of pyrochlore type Ce₂Zr₂O₇ was confirmed by adding a Fe oxide.

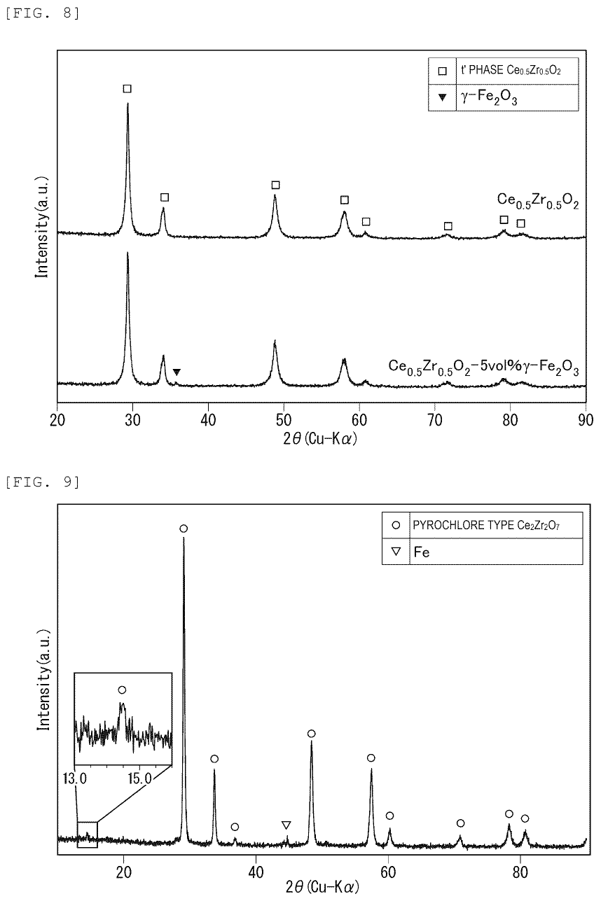

FIG. 8 shows an XRD pattern of a sample added with γ-Fe₂O₃ and Ce_{0.5}Zr_{0.5}O₂ prepared by the solid-state reaction method. All the observed peaks of Ce_{0.5}Zr_{0.5}O₂ prepared by the solid-state reaction were attributed to the tetragonal fluorite type structure of Ce_{0.5}Zr_{0.5}O₂ having a space group P4₂/nmc, and peaks derived from γ-Fe₂O₃ were observed in the composite.

In the XRD pattern in FIG. 8, a peak indicated by “Q” attributes to fluorite type Ce_{0.5}Zr_{0.5}O₂, and a peak indicated by “T” is a peak attributed to γ-Fe₂O₃.

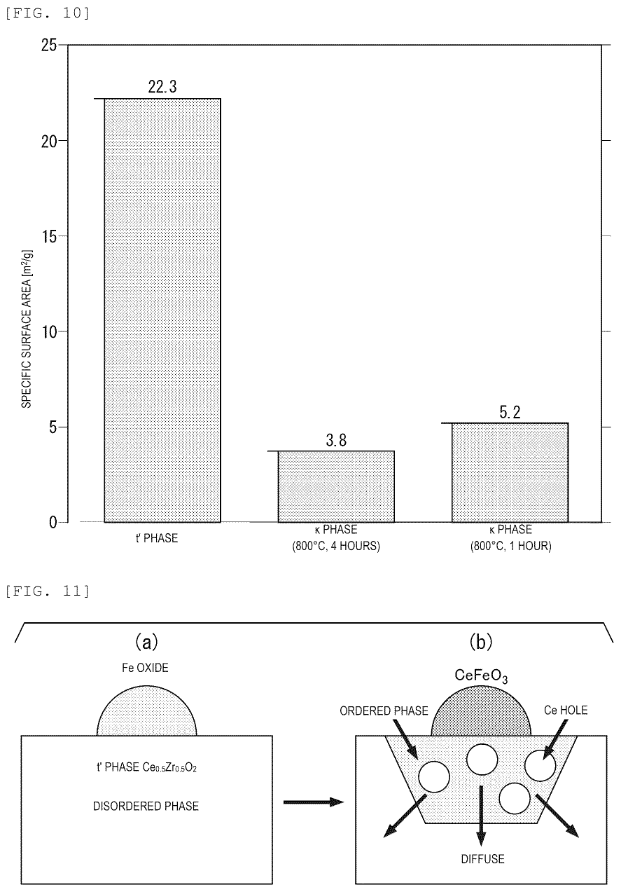

FIG. 9 shows an XRD pattern of Ce_{0.5}Zr_{0.5}O₂-γ-Fe₂O₃ obtained after a reduction heat treatment in an atmosphere of 5% H₂—Ar at 800° C. for 3 hours. After the reduction, the peak derived from the ordering of cations was observed near 14.5°, and it was found that the phase changed to the pyrochlore type Ce₂Zr₂O₇. Therefore, it was found that even in the case of Ce_{0.5}Zr_{0.5}O₂ prepared by the solid-state reaction method, the low-temperature synthesis of the pyrochlore type Ce₂Zr₂O₇ by the addition of a Fe oxide was able to be performed.

In the XRD pattern in FIG. 9, a peak indicated by “◯” is a peak attributed to pyrochlore type Ce₂Zr₂O₇, and a peak indicated by “ [symbol] ” is a peak attributed to Fe.

(7) Specific Surface Areas of t′ Phase Prepared by Pechini Method and κ Phase Prepared by Adding 5 vol % α-Fe₂O₃ to t′ Phase

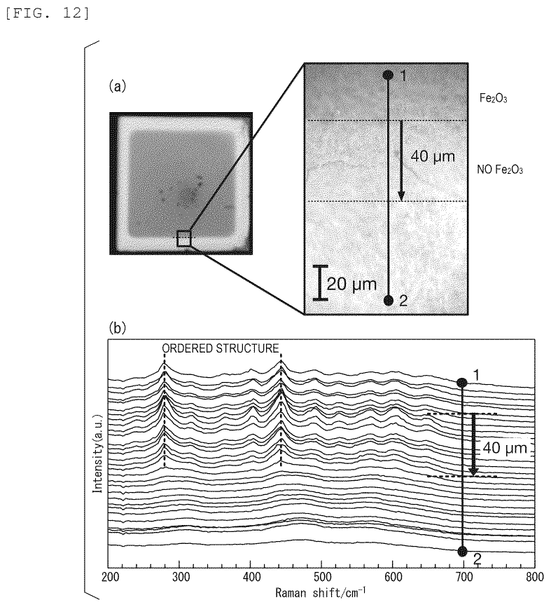

FIG. 10 is a graph comparing specific surface areas of the t′ phase prepared by the Pechini method and the κ phase prepared by adding 5 vol % α-Fe₂O₃ to the t′ phase.

In FIG. 10, the t′ phase was a phase prepared by the Pechini method and then not subjected to a reduction heat treatment, and the κ phase was a phase subjected to a reduction heat treatment in an atmosphere of 5% H₂—Ar at 800° C. for 5 hours and a phase subjected to a reduction heat treatment in an atmosphere of 5% H₂—Ar at 800° C. for 1 hour. The κ phase was subjected to an oxidation treatment in the air at 800° C. for 2 hours.

The specific surface area of the t′ phase is 22.3 [m²/g], and the specific surface areas of the κ phase according to the invention are 3.8 [m²/g] and 5.2 [m²/g], respectively. The specific surface areas of the κ phase according to the invention were respectively about 11 times and about 15 times the specific surface area of the κ phase reported in NPL 1.

Average particle diameters of the t′ phase, the κ phase (subjected to the reduction heat treatment at 800° C. for 5 hours), and the κ phase (subjected to the reduction heat treatment at 800° C. for 1 hour) were 40.6 nm, 174 nm, and 324 nm, respectively. The average particle diameter was calculated on an assumption that particles were spherical using the measured specific surface area.

FIG. 11 is a conceptual diagram showing a mechanism related to cation ordering of a ceria-zirconia composite oxide due to the presence of Fe ions. First, CeFeO₃ is formed at an interface of a Fe oxide at 800° C., and Ce³⁺ and Ce vacancies formed in this process promote cation diffusion. In order to maintain electrical neutrality, oxygen is released from a surface of the t′ phase Ce_{0.5}Zr_{0.5}O₂ (hereinafter, sometimes referred to as “CZ55”) or via CeFeO₃ having the highest oxygen transport capacity. In general, an ordered phase is thermodynamically more stable at a low temperature than a disordered phase. In addition, thermal energy is dynamically required for the diffusion, and particularly, the thermal energy is required for the slow diffusion of cations. As described above, when a sufficiently high mobility for rearranging a cation arrangement is achieved at a low temperature, the formation of the ordered phase easily proceeds. This is a case of a ceria-zirconia composite oxide doped with Fe₂O₃. Further, it is presumed that when the ordered phase is formed as a seed, an ordered phase region spreads over the entire region by a strain caused by a difference in molar volume between the ordered phase and the disordered phase as a driving force.

In order to verify the mechanism shown in FIG. 11, as shown in (a) in FIG. 12, a Fe₂O₃ thin film was deposited by PLD on a t′ phase CZ55 powder layer having a thickness of 3 μm formed on a quartz substrate to form a model interface. Next, a reduction heat treatment was performed at 900° C. for 5 hours, then a boundary between a region in which the Fe₂O₃ thin film was deposited (Fe₂O₃; region 1) and a region in which the Fe₂O₃ thin film was not deposited (no Fe₂O₃; region 2) in (a) in FIG. 12 was subjected to line scanning by a Raman spectrum method to obtain a Raman spectrum shown in (b) in FIG. 12. Near the region 1 where CZ55 was covered with the Fe₂O₃ thin film, peaks caused by a cation-ordered structure were clearly observed near 280 cm⁻¹ and 440 cm⁻¹. A region having the cation-ordered structure is further extended by 40 μm in length toward the region 2 not covered with the Fe₂O₃ thin film. This is a piece of direct evidence that cation ordering occurs in the presence of Fe₂O₃ and the ordered region can be rapidly expanded to the vicinity with a scale of several tens of μm. It should be noted that the cation ordering of CZ55 at a low temperature in the presence of Fe₂O₃ occurs only in the powder sample, and does not occur in a fired bulk sample. This suggests that a mechanical stress and a stress due to lattice mismatch around the interface in (b) in FIG. 11 may play an important role in the expansion of the cation ordering in the ceria-zirconia composite oxide. Fe is considered to have a role in promoting cation ordering of CZ55 without being formed as a solid solution in CZ55.

### REFERENCE SIGNS LIST

1: oxygen storage material
2: three-way catalyst
3: carrier

1. An oxygen storage material having a chemical composition represented by Ce1-xZrxO2-δ (0.45≤x≤0.65, 0≤δ), having a peak attributed to a cubic pyrochlore-like structure (κ phase) near 14.5° in an XRD pattern, and having a specific surface area of 3 [m2/g] or more.

2. The oxygen storage material according to claim 1, wherein the specific surface area is 3.5 [m2/g] or more.

3. The oxygen storage material according to claim 2, wherein the specific surface area is 5 [m2/g] or more.

4. The oxygen storage material according to claim 1, which has a peak attributed to Fe in the XRD pattern.

5. A catalyst for purifying exhaust gas comprising:
the oxygen storage material according to claim 1.

6. A method for producing an oxygen storage material, which is a method for producing the oxygen storage material according to claim 1, comprising:
a composite preparation stage of preparing a composite in which a Fe compound is added to an oxide having a chemical composition represented by Ce1-xZrxO2-δ (0.45≤x≤0.65, 0≤δ); and
a reduction heat treatment stage of subjecting the composite to a reduction heat treatment at a temperature of 700° C. or higher and 850° C. or lower.

7. The method for producing an oxygen storage material according to claim 6, wherein in the composite preparation stage, the Fe compound is added in an amount of 1 vol % or more and 10 vol % or less with respect to the oxide having the chemical composition represented by Ce1-xZrxO2-δ (0.45≤x≤0.65, 0≤δ).

8. The oxygen storage material according to claim 2, which has a peak attributed to Fe in the XRD pattern.

9. The oxygen storage material according to claim 3, which has a peak attributed to Fe in the XRD pattern.

10. A catalyst for purifying exhaust gas comprising:
the oxygen storage material according to claim 2.

11. A catalyst for purifying exhaust gas comprising:
the oxygen storage material according to claim 3.

12. A catalyst for purifying exhaust gas comprising:
the oxygen storage material according to claim 4.

13. A method for producing an oxygen storage material, which is a method for producing the oxygen storage material according to claim 2, comprising:
a composite preparation stage of preparing a composite in which a Fe compound is added to an oxide having a chemical composition represented by Ce₁₋ₓZrₓO_{2-δ} (0.45≤x≤0.65, 0≤δ); and
a reduction heat treatment stage of subjecting the composite to a reduction heat treatment at a temperature of 700° C. or higher and 850° C. or lower.

14. A method for producing an oxygen storage material, which is a method for producing the oxygen storage material according to claim 3, comprising:
a composite preparation stage of preparing a composite in which a Fe compound is added to an oxide having a chemical composition represented by Ce₁₋ₓZrₓO_{2-δ} (0.45≤x≤0.65, 0≤δ); and
a reduction heat treatment stage of subjecting the composite to a reduction heat treatment at a temperature of 700° C. or higher and 850° C. or lower.

15. A method for producing an oxygen storage material, which is a method for producing the oxygen storage material according to claim 4, comprising:
a composite preparation stage of preparing a composite in which a Fe compound is added to an oxide having a chemical composition represented by Ce₁₋ₓZrₓO_{2-δ} (0.45≤x≤0.65, 0≤δ); and
a reduction heat treatment stage of subjecting the composite to a reduction heat treatment at a temperature of 700° C. or higher and 850° C. or lower.
